(19) United States
(12) Patent Application Publication
(10) Pub. No.: US 2010/0012663 A1
(43) Pub. Date: Jan. 21, 2010

(54) Protective Cap For A Pressurized Tank

(76) Inventors: Philippe Andreani, Feucherolles (FR); Gilles Cannet, Parmain (FR); Renaud Ligonesche, Herblay (FR); Alessandro Moretti, Brescia (IT)

Correspondence Address: AIR LIQUIDE;Intellectual Property, 2700 POST OAK BOULEVARD, SUITE 1800, HOUSTON, TX, 77056, US

(21) Appl. No.: 12/439,199

(22) PCT Filed: Jul. 9, 2007
(86) PCT No.: PCT/FR2007/051617

§ 371 Date: Jun. 25, 2009

(30) Foreign Application Priority Data
Sep. 1, 2006 (FR) 0653551

(51) Int. Cl. F17C 13/06

(52) U.S. Cl. 220/582

(57) ABSTRACT

Protective cap for a pressurized tank, in particular, for the protection of an air pressure regulator device(s) mounted on a cylinder of pressurized gas (3,4, comprising at least two components (5,6) (10) to be mounted together and on the tank (4) so as to form a pressure enclosure, with at least two of the components (5,6; 15, 16) being mechanically connected by at least one connecting system (7), allowing at least one limited relative displacement between the components (5, 6; 15, 16), with at least two components (5, 6) forming the covering, complementary and distinct portions of the cap (15) in the assembled position.

The present invention relates to a protective cap for a container of fluid.

The invention relates more specifically to a protective cap for a fluid container, particularly for protecting a valve/regulator device mounted on a cylinder of pressurized gas, comprising at least two parts intended to be assembled with one another and with the container in such a way as to form a cowling.

The valves or pressures regulating valves with which cylinders of pressurized fluid are fitted are generally protected against knocks and various forms of attack by an accessory known as a cap which may be “open” or “closed” (cf. standard NF E29-640).

A closed cap affords the valve full protection when in place but has to be removed to provide access to said valve. Thus, a closed cap no longer protects the valve when the cylinder is in use.

Open caps are relatively simple when they are designed to protect conventional valves. In general, caps for valves with in-built pressure regulators (IRVs) are more sophisticated because of their opening that provide access to the controls and allow sight of pressure gauges (cf. document FR 2 774 452 A1 by way of example).

A removable cap is of benefit in terms of valve maintenance and also for the purposes of maintaining the cap itself (painting, cleaning, repair or replacement operations). However, fitting and removing the cap need to be relatively simple and the attachment needs to be reliable enough that any loosening or loss of the cap during handling and transport is avoided. In order to allow access to the controls and sight of the pressure gauges or other components, the cap has to be positioned accurately heightwise and in terms of angle relative to the valve.

Finally, the cap needs to be able to accommodate the type of attachment available on the cylinder to which it is fitted (such as a “collar” for example in accordance with standard NF EN 962). However, there are various types of protective cap attachments: plain collars, threaded collars with various diameters. The collars generally have an outside diameter greater than the spatial envelope of most conventional valves. This allows the cap to be mounted on a valve that has already been mounted on the container. However, a great many valves, particularly valves with inbuilt pressure regulators (IRVs) have a spatial envelope that exceeds the outside diameter of the collars.

One known solution is to provide a removable cap that can be assembled with the cylinder without removing the valve, that is to say a cap that can be mounted on the cylinder after the valve.

For example, the cap is made up of two substantially symmetrical enveloping half-caps or a single enveloping piece intended to collaborate with a non-enveloping connecting piece such as an attachment flange. The two pieces that make up the cap are, for example, assembled by screwing.

Fitting these caps is generally a complicated procedure for an operator. What an operator actually has to do is to position the two independent pieces that make up the cap relative to one another and screw them together using attachment pins. This mounting is particularly tiresome in the case of a metal cap and if the center of gravity of each part lies outside of the vertical plane containing the collar of the container (because the half-caps then have a tendency not to remain in the mounted position during screwing).

One known solution is to provide a second operator to hold the parts of the cap together while they are being assembled by the first operator. However, such a solution is costly on an industrial scale.

Another solution is to provide means of temporarily holding the two parts of the cap, for example a sticky tape or a tie, to hold them together during screwing and which is then removed. This solution is likewise neither economical nor appropriate on an industrial scale.

Another solution is to provide mating retaining means on the two parts, for example elastic attachment clip systems sufficiently engineered that they hold the two parts together during the actual assembly proper (for example during screw fastening). However, this solution is ill-suited to caps made of metal. When the mating retaining means situated on the two parts are of the type involving magnetization, this makes the caps heavier and more expensive.

It is an object of the present invention to alleviate all or some of the abovementioned drawbacks of the prior art.

To this end, the protective cap for a container of fluid according to the invention, in other respects in accordance with the generic description thereof given in the above preamble, is essentially characterized in that the two parts are mechanically connected by at least one connecting system allowing the parts a limited relative movement.

Furthermore, some embodiments of the invention may comprise one or more of the following features:
in the mounted position, said cap comprises a lower portion and an upper portion which are aligned in a direction known as the direction of elevation, and in that the connecting system comprises a pivot pin, common to the parts,
the connecting system comprises a single pivot pin common to the two parts and substantially parallel or substantially perpendicular to the direction of elevation,
the connecting system comprises two pivots common to the two parts,
the axis of the two common pivots is substantially perpendicular to the direction of elevation,
at least one of the parts of the cap comprises at least one member capable of urging the parts into their position of assembly with one another and/or of temporarily holding them in such a position,
the member or members capable of urging the parts into their position of assembly with one another or of holding them in that position comprise one or more of the following elements: an elastic connection, magnetization,
the at least two parts intended to be assembled comprise two enveloping half-caps that have substantially identical overall shapes or volumes,
at least two parts intended to be assembled comprise an enveloping cap and an non-enveloping connecting piece such as a flange.

Other particulars and advantages will become apparent from reading the following description which is given with reference to the figures in which:

FIG. 1 depicts a side view of a protective cap according to a first exemplary embodiment of the invention, in the non-mounted position,

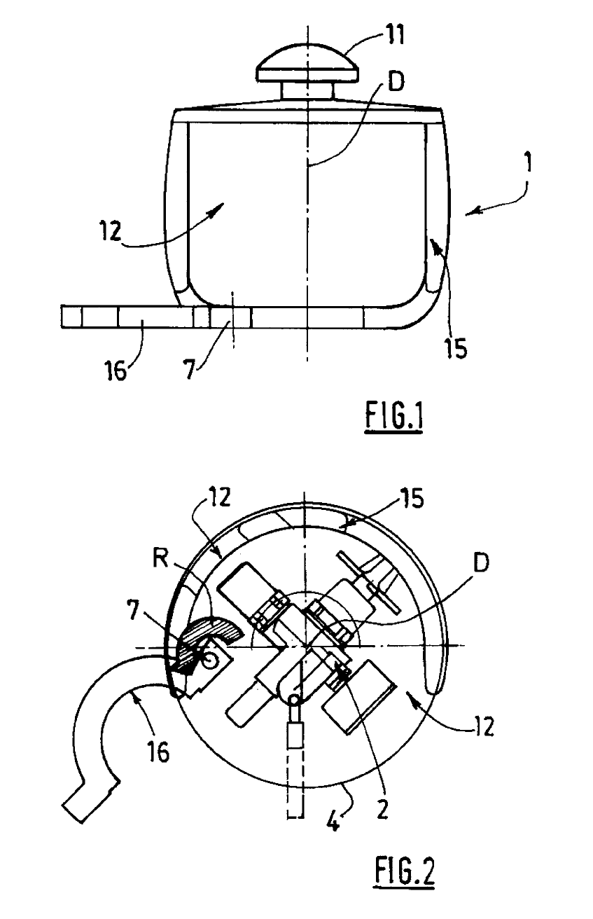

FIG. 2 depicts a plan view of the cap of FIG. 1 in a position in which it is partially mounted on a cylinder of fluid fitted with a pressure regulating valve and in which the upper wall of the cap is not depicted,

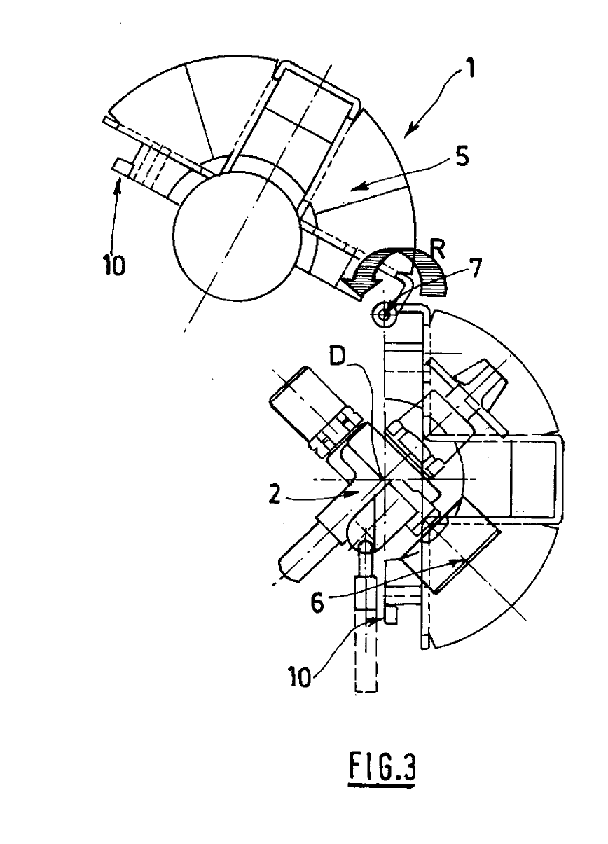

FIG. 3 depicts a plan view of a protective cap according to a second exemplary embodiment of the invention, illustrating how it is mounted around a pressure regulating valve,

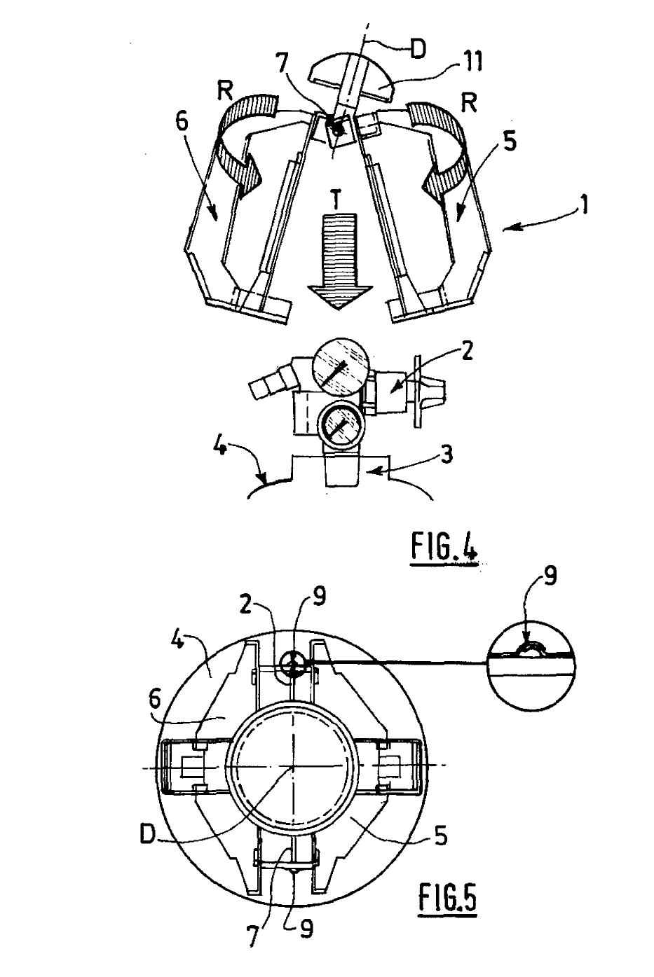

FIG. 4 depicts a side view of a protective cap according to a third exemplary embodiment of the invention, illustrating how it is mounted on a cylinder of fluid fitted with a pressure regulating valve,

FIG. 5 depicts a plan view of the cap of FIG. 4 in the position in which it is mounted on a cylinder of fluid fitted with a pressure regulating valve and with one detail enlarged.

In the exemplary embodiment of FIGS. 1 and 2, the cap 1 has the overall shape of a cylinder comprising a lower region that forms a base intended to be mounted on the neck of a bottle 4 (directly or via an intermediate means of attachment such as an attaching ring which has not been depicted) and a casing- or shell-form upper region intended to house a pressure regulating valve 2.

The shell may comprise one or more lateral apertures 12 for accessing the valve 2 and has a top wall comprising a central handling pommel 12.

The protective casing or shell is formed of a first part 15 of the cap 1 which part is connected by a pivot 7 to a second cap part 16 that forms a half-annulus-shape detachment flange. The second part 16 is intended to collaborate with the bottom of the first part 15 to encircle the neck of the cylinder 4.

Thus, only the first part 15 of the cap 1 performs an enveloping function of protecting a valve 2, the second part being designed to secure the whole to a cylinder 4. To do this, and in a way known per se, the first 15 and second 16 parts may have tapped orifices that can be made to coincide to allow them to be joined together and to allow the whole to be clamped around the neck of the cylinder 4.

According to an advantageous specific feature, the two parts that make up the cap 1 are rigidly (and preferably indissociably) connected by a pivot 7. The pivot 7 is located for example between one end of the flange 16 (second part) and a lower region of the first part 15. For example, the pivot axis of the pivot is substantially parallel to the vertical direction D of the cap. Thus, the movement of the second part 16 relative to the first part is in a direction perpendicular to the neck of the cylinder 4. What that means is that by first of all positioning the first part on the neck of the cylinder 4 (for example laterally in a direction perpendicular to the axis of the cap 1), the operator can then easily move the second part 16 in the direction of clamping of the neck of the cylinder 4 (rotation R).

In this way, it becomes easier for an operator to fit the cap 1 onto a cylinder. The pivot connection allows for ease of positioning and ease of retention during actual attachment (screw fastening). In particular, the rigid pivot connection 7 contributes to the attachment and retention of the whole. The same advantages are obtained when the cap 1 is being removed.

FIG. 3 depicts an embodiment variant in which the cap comprises two parts 5, 6 forming half caps. What this means is that the two parts 5, 6 are enveloping and substantially symmetrical (in the manner of half shells). As before, the two parts 5, 6 are connected by a pivot 7 the pivot axis of which is parallel to the vertical axis D (known as the axis of elevation) of the cap 1. for conciseness, the elements which are identical to those described hereinabove are denoted by the same numerical references and are not described a second time. As depicted, the two parts may comprise members capable of urging the two parts 5, 6 into their assembly position or alternatively of holding them more firmly in that position. For example, the two parts 5, 6 may comprise mating magnets, ferromagnetic inserts or the like intended to face one another in the position of assembly.

In the embodiment depicted in FIGS. 4 and 5, the cap 1 comprises two parts 5, 6 of substantially symmetrical overall shape (or two cage-like enveloping half-shells) pivot-connected at their upper parts). More specifically, the two parts 5, 6 are connected at two separate pivots 7 situated at two ends of the cap 1 respectively. The pivot axes of the two pivots 7 here coincide. As depicted in FIG. 4, in order to mount them on a cylinder, the two parts 5, 6 of the cap 1 can be opened up like a gripper (rotation R) to allow them to be mounted from the top around the neck 3 of the cylinder around a valve 2 (translational movement T).

Once again, the fitting of the cap 1 to a cylinder is easier for an operator to perform. The pivot connection 7 allows the two parts 5, 6 to be positioned and held naturally in the position of assembly (because the position of the pivot pins 7 above the centers of gravity of the parts 5, 6 naturally tends to cause the two parts 5, 6 to close together into the position of assembly (particularly when the cap 1 is held at the top, for example at a pommel 11)).

In order to make mounting and assembly easier still, the two parts 5, 6 may comprise members capable of urging the two parts 5, 6 into their position of assembly or of keeping the two parts more firmly in that position. For example, the two parts 5, 6 may comprise elastic retaining systems such as mating clips 9 or the like intended to collaborate in the position of assembly.

The parts that form the cap 1 may be made of plastic and/or of metal and/or of any appropriate material or mixture.

The invention is not restricted to the exemplary embodiments described hereinabove; in particular, equivalents of all the elements described hereinabove may be used. In addition, all or some of the constituent parts and/or functions of the various embodiments discussed hereinabove may be combined. Likewise, the cap 1 may comprise more than two parts mechanically connected by at least one connecting system that allows limited relative movement.

In addition, the cap may, in order to attach it, use a ring that forms a mounting interface intended to be inserted between the neck of the cylinder and the parts that form the cowling. Advantageously, the ring may have an opening or cutout on its circumference designed for fitting it or removing it relative to the cylinder (so as to form an open annulus). The opening in the ring may thus, when the ring is being fitted or removed, form a passage for a portion or section of a cylinder or of a valve 2 mounted on the cylinder.

1-13. (canceled)

14. A protective cap for a fluid container comprising at least two parts intended to be assembled with one another and with the container in such a way as to form a cowling, the at least two parts being mechanically connected by at least one connecting system thereby allowing the parts a limited relative movement, and the at least two parts in the assembled position forming portions of the cap which are enveloping, complementary and separate.

15. The cap of claim 14, wherein the cap comprises two parts intended respectively, in the assembled position, to form two enveloping half-caps.

16. The cap of claim 14, wherein the at least two of the parts intended to be assembled each comprise a base portion intended to be mounted on the neck of a container, directly or via an intermediate attachment means.

17. The cap of claim 16, wherein the cap comprises two parts that respectively form two enveloping half-caps that have substantially identical or symmetrical overall shapes or volumes.

18. The cap of claim 16, wherein taken in combination, the base portions of the two parts each consist of an attachment flange in the shape of a half-annulus.

19. The cap of claim 14, wherein in the mounted position, the cap comprises a lower portion and an upper portion which are aligned in a direction (D) known as the direction of elevation, and in that the connecting system comprises a pivot pin, common to the parts.

20. The cap of claim 19, wherein the connecting system comprises a single pivot pin common to the two parts and either substantially parallel or substantially perpendicular to the direction (D) of elevation.

21. The cap of claim 19, wherein the connecting system comprises two pivots common to the two parts.

22. The cap of claim 20, wherein the axis of the two common pivots is substantially perpendicular to the direction (D) of elevation.

23. The cap of claim 14, wherein at least one of the parts of the cap comprises at least one member capable of urging the parts into their position of assembly with one another and/or of temporarily holding them in such a position.

24. The cap of claim 23, wherein the member or members capable of urging the parts into their position of assembly with one another or of holding them in that position comprise an elastic connection, magnetization or a combination of an elastic connection and magnetization.

25. The cap of claim 14, wherein at least two parts intended to be assembled comprise an enveloping cap and an non-enveloping connecting piece such as a flange.

26. The cap of claim 14, wherein the cap is for protecting a valve/regulator device mounted on a cylinder of pressurized gas.

27. The cap of claim 16, wherein the attachment means is a ring.

28. The cap of claim 17, wherein taken in combination, the base portions of the two parts each consist of an attachment flange in the shape of a half-annulus.

29. The cap of claim 17, wherein in the mounted position, the cap comprises a lower portion and an upper portion which are aligned in a direction (D) known as the direction of elevation, and in that the connecting system comprises a pivot pin, common to the parts.

30. The cap of claim 29, wherein the connecting system comprises a single pivot pin common to the two parts and either substantially parallel or substantially perpendicular to the direction (D) of elevation.

31. The cap of claim 29, wherein the connecting system comprises two pivots common to the two parts.

32. The cap of claim 15, wherein the at least two of the parts intended to be assembled each comprise a base portion intended to be mounted on the neck of a container, directly or via an intermediate attachment means.

33. The cap of claim 32, wherein the cap comprises two parts that respectively form two enveloping half-caps that have substantially identical or symmetrical overall shapes or volumes.

34. The cap of claim 32, wherein taken in combination, the base portions of the two parts each consist of an attachment flange in the shape of a half-annulus.

35. The cap of claim 33, wherein in the mounted position, the cap comprises a lower portion and an upper portion which are aligned in a direction (D) known as the direction of elevation, and in that the connecting system comprises a pivot pin, common to the parts.

36. The cap of claim 34, wherein in the mounted position, the cap comprises a lower portion and an upper portion which are aligned in a direction (D) known as the direction of elevation, and in that the connecting system comprises a pivot pin, common to the parts.

37. A fluid container comprising:
a cylinder of gas under pressure having a valve with an in-built pressure regulating device; and
a protective cap having at least two parts intended to be assembled with one another and with the cylinder in such a way as to form a cowling, the at least two parts being mechanically connected by at least one connecting system thereby allowing the parts a limited relative movement, and the at least two parts in the assembled position forming portions of the cap which are enveloping, complementary and separate.
